(19) United States
(12) Patent Application Publication
(10) Pub. No.: US 2007/0158251 A1
(43) Pub. Date: Jul. 12, 2007

(54) Water treatment unit for bottle

(76) Inventor: Yiu Chau Chau, Richmond Hill (CA)

Correspondence Address: Intellectual Property Department;DEWITT ROSS & STEVENS, S.C., Firstar Financial Centre, 8000 Excelsior Drive, Suite 401, Madison, WI, 53717-1914, US

(21) Appl. No.: 11/328,366

(22) Filed: Jan. 9, 2006

(51) Int. Cl. C02F 1/48

(52) U.S. Cl. 210/223; 210/282; 210/266; 210/443

(57) ABSTRACT

A water treatment unit includes any combination of the following filtering and treatment elements such as a vertical pre-filter element, an inner vertical pre-treatment element, a first chamber containing a first treatment medium which water to be treated flows in a radically horizontal direction, a second chamber containing a second treatment medium which water to be treated flows in a vertical direction and a third chamber containing a third treatment medium which water to be treated flows in an annular direction. Water treatment unit with a third chamber containing a third treatment medium which water to be treated flows in an annular direction extends the length of water flow path within the water treatment unit significantly. The inlet connector is also provided with different arrangements such that the bottle, with or without the water treatment unit, is suitable for tip up for drinking water and/or drinking water with bottle in a vertical position.

### FIELD OF THE INVENTION

The present invention generally relates to the field of water treatment unit typically includes any combination of the following filtering and treatment elements such as a vertical pre-filter element, an inner vertical pre-treatment element, a first chamber containing a first treatment medium which water to be treated flows in a radically horizontal direction, a second chamber containing a second treatment medium which water to be treated flows in a vertical direction and a third chamber containing a third treatment medium which water to be treated flows in an annular direction. The water treatment unit also provides different arrangements of inlet connector such that the bottle is suitable for tip-up for drinking water and/or drinking water with bottle in a vertical position.

### BACKGROUND OF THE INVENTION

U.S. Pat. No. 6,193,886 illustrates and describes a bottle mounted water treatment unit located at the top of the bottle with water flowing radically into the water treatment unit. However, air can be ingested through the filter when the bottle is approaching empty. U.S. Pat. No. 5,211,973 illustrates and describes a bottle mounted water treatment unit located at the bottom of the bottle with water flowing into the water treatment unit from the bottom and virtually preventing air from ingesting through the filter when the bottle is approaching empty. U.S. Pat. No. 6,153,096 illustrates and describes another bottle mounted water treatment unit located either at the top or at the bottom of the bottle having a shroud mounted at one end of the filter element and defining an annular siphon space for allowing water to flow into the water treatment unit, thus minimizing the air being ingested through the filter significantly. Notwithstanding, there is still room for improvement.

It is therefore advantageous to design a water treatment unit to devoid the shortcomings associated with prior art water treatment unit and to improve upon them.

### SUMMARY OF THE INVENTION

The water treatment unit of the present invention is cylindrical in shape with outlet tube located at the center of the top surface of the water treatment unit. The water treatment unit is mounted at the top of the bottle with outlet tube of the water treatment unit connected to the outlet tube of the closure device of the bottle.

The water treatment unit typically includes any combination of the following filtering and treatment elements such as a vertical pre-filter element, an inner vertical pre-treatment element, a first chamber containing a first treatment medium which water to be treated flows in a radically horizontal direction, a second chamber containing a second treatment medium which water to be treated flows in a vertical direction and a third chamber containing a third treatment medium which water to be treated flows in an annular direction. The design for allowing water to flow into the unit can be either an up flow design or a down flow design.

The present invention provides a third chamber containing a third treatment medium which water to be treated flows in an annular direction, thus extending the length of water flow path significantly. For a cylindrical water treatment unit of diameter 2 inches and height 2 inches, the maximum water flow path within the water treatment unit is 2 inches. If the same water treatment unit includes a third chamber containing a third treatment medium which water to be treated flows in an annular direction with mean diameter of annular water flow path 1.5 inches, then just considering the annular post-treatment element only, the length of water flow path is already extended to 4.7 inches (1.5×3.1416).

The present invention provides an inlet connector located on the bottom of the cylindrical wall of the filter assembly with two inlets—one facing up inlet and one facing down inlet.

One principal aspect of the present invention is that when putting a tube onto the facing up inlet and covering up the facing down inlet, the design is suitable for tipping up the bottle for drinking water. Conversely, when putting a tube onto the facing down inlet and covering up the facing up inlet, the design is suitable for drinking water with the bottle in vertical position.

Another principal aspect of the present invention is that when putting a tube with check valve mechanism onto the facing up inlet and another tube also with check valve mechanism onto the facing down inlet, when the bottle is tipped up for drinking water, the check valve mechanism in the tube onto the facing down inlet is activated and the water flow is blocked. Therefore, water is flowing from the facing up tube only. When drinking water with bottle in vertical position, the check valve mechanism in the tube onto the facing up inlet is activated and the water flow is blocked. Therefore, water is flowing from the facing down tube only.

With modification, the inlet connector located on the bottom of the cylindrical wall of the water treatment unit with only one inlet can be rotated freely.

One principal aspect of the modified invention is that when the inlet is rotated to a position facing up and putting a tube onto the facing up inlet, the design is suitable for tipping up the bottle for drinking water. Conversely, when the inlet is rotated to a position facing down and putting a tube onto the facing down inlet, the design is suitable for drinking water with bottle in vertical position.

With another modification, the inlet tube of the water treatment unit is also located at the center of the top surface of the water treatment unit with inner wall of the inlet tube larger than the outer wall of outlet tube. When the bottle is tipped up for drinking water, water will flow into the water treatment unit through the annular gap in between the outer wall of the outlet tube and the inner wall of the inlet tube.

Accordingly, a preferred embodiment of the present invention provides a water treatment unit integrated in a container for treating water in the container which flows through the water treatment unit. The unit comprises an inlet connector with two inlets attached to the bottom of the unit: with one inlet facing up and the other inlet facing down; whereby when one of the inlets is covered up, then a tube is connected to the other one of the inlets for introducing water to be treated by the unit. It further comprises an outlet tube positioned at the center of the top surface of the unit for discharging water which has been treated by the unit. Furthermore, the unit comprises a first chamber containing a first treatment medium through which water to be treated flows in a radically horizontal direction during treatment; and whereby during treatment water flows from the inlet connector and through the unit and the outlet tube.

### BRIEF DESCRIPTION OF THE DRAWINGS

Advantages and features of the invention will become more apparent with reference to the following description of the presently preferred embodiment thereof in connection with accompanying drawings, wherein like references have been applied to like elements, in which:

FIG. 1 is a cross-sectional view of a bottle with the water treatment unit showing a tube is attached to the facing up inlet and the facing down inlet is covered up;

FIG. 2 is a cross-sectional view of a bottle with the water treatment unit showing a tube is attached to the facing down inlet and the facing up inlet is covered up;

FIG. 3 is a cross-sectional view of a bottle with the water treatment unit showing a tube is attached to the inlet which have been rotated to a facing up position;

FIG. 4 is a cross-sectional view of a bottle with the water treatment unit showing a tube is attached to the inlet which have been rotated to a facing down position;

FIG. 5 is a cross-sectional view of a bottle with the water treatment unit showing the bottle is tipped up for drinking water with the check valve mechanism in the tube onto the facing down inlet is activated and the water can flow through the facing up tube only;

FIG. 6 is a cross-sectional view of a bottle with the water treatment unit showing the bottle is in vertical position with the check valve mechanism in the tube onto the facing up inlet is activated and the water can flow through the facing down tube only;

FIG. 7 is a cross-sectional view of a bottle without the water treatment unit showing the bottle is tipped up for drinking water with the check valve mechanism in the tube onto the activated facing down inlet and the water can flow through the facing up tube only;

FIG. 8 is a cross-sectional view of a bottle without the water treatment unit showing the bottle is in vertical position with the check valve mechanism in the tube onto the activated facing up inlet and the water can only flow through the facing down tube only;

FIG. 9 is a cross-sectional view of a bottle with the water treatment unit showing the bottle is tipped up for drinking water with water flowing into the filter assembly through the annular gap in between the outer wall of the outlet tube and the inner wall of the inlet tube;

FIG. 10 is an exploded view of a preferred embodiment of water treatment unit including a vertical pre-filter element, a first chamber containing a first treatment medium which water to be treated flows in a radically horizontal direction, a second chamber containing a magnetic treatment element and a third chamber containing a third treatment medium which water to be treated flows in an annular direction;

FIG. 11 is an exploded view of a preferred embodiment of water treatment unit including a vertical pre-filter element, a first chamber containing a first treatment medium which water to be treated flows in a radically horizontal direction, a second chamber containing a sub-micorn filter which water to be treated flows in a vertical direction and a third chamber containing a third treatment medium which water to be treated flows in an annular direction;

FIG. 12 is a cross-sectional view of the down flow design water treatment unit including a vertical pre-filter element, a first chamber containing a first treatment medium which water to be treated flows in a radically horizontal direction and a third chamber containing a third treatment medium which water to be treated flows in an annular direction;

FIG. 13 is a cross-sectional view of the down flow design water treatment unit including a vertical pre-filter element, a first chamber containing a first treatment medium which water to be treated flows in a radically horizontal direction and a second chamber containing a magnetic treatment element which water to be treated flows in a vertical direction;

FIG. 14 is a cross-sectional view of the down flow design water treatment unit including a vertical pre-filter element, a first chamber containing a first treatment medium which water to be treated flows in a radically horizontal direction and a second chamber containing a sub-micron filter which water to be treated flows in a vertical direction;

FIG. 15 is a cross-sectional view of the down flow design water treatment unit including a vertical pre-filter element and a first chamber containing a first treatment medium which water to be treated flows in a radically horizontal direction;

FIG. 16 is a cross-sectional view of the down flow design water treatment unit including only a first chamber containing a first treatment medium which water to be treated flows in a radically horizontal direction;

FIG. 17 is a cross-sectional view of the up flow design water treatment unit including a vertical pre-filter element, an inner pre-treatment element, a first chamber containing a first treatment medium which water to be treated flows in a radically horizontal direction, and a second chamber containing a magnetic treatment element which water to be treated flows in a vertical direction;

FIG. 18 is a cross-sectional view of the up flow design water treatment unit including a vertical pre-filter element, an inner pre-treatment element, a first chamber containing a first treatment medium which water to be treated flows in a radically horizontal direction, a second chamber containing a magnetic treatment element which water to be treated flows in a vertical direction and a third chamber containing a third treatment medium which water to be treated flows in an annular direction;

FIG. 19 is a cross-sectional view of the up flow design water treatment unit including a vertical pre-filter element, a first chamber containing a first treatment medium which water to be treated flows in a radically horizontal direction, and a third chamber containing a third treatment medium which water to be treated flows in an annular direction;

FIG. 20 is a cross-sectional view of the up flow design water treatment unit including a vertical pre-filter element, a first chamber containing a first treatment medium which water to be treated flows in a radically horizontal direction, a second chamber containing a magnetic treatment element which water to be treated flows in a vertical direction and a third chamber containing a third treatment medium which water to be treated flows in an annular direction;

FIG. 21 is a cross-sectional view of the up flow design water treatment unit including a vertical pre-filter element and a first chamber containing a first treatment medium which water to be treated flows in a radically horizontal direction;

FIG. 22 is a cross-sectional view of the up flow design water treatment unit including only a first chamber containing a first treatment medium which water to be treated flows in a radically horizontal direction.

### DETAILED DESCRIPTION OF THE PREFERRED EMBODIMENTS

A water treatment unit incorporated in a container for treating water in the container which flows through the unit is disclosed herein. The unit is comprised of an inlet connector with two inlets attached to the bottom such that one inlet facing up and the other inlet facing down. When one of the inlets is covered up, then a tube is connected to the other one of the inlets for introducing water to be treated by the unit. It is also comprised of an outlet tube positioned at the center of the top surface of the water treatment unit for discharging water which has been treated by the unit. The water treatment unit according to the present invention also comprises a first chamber containing a first treatment medium through which water to be treated flows in a radically horizontal direction during treatment; and whereby during treatment, water flows from the inlet connector, through the unit and the outlet tube.

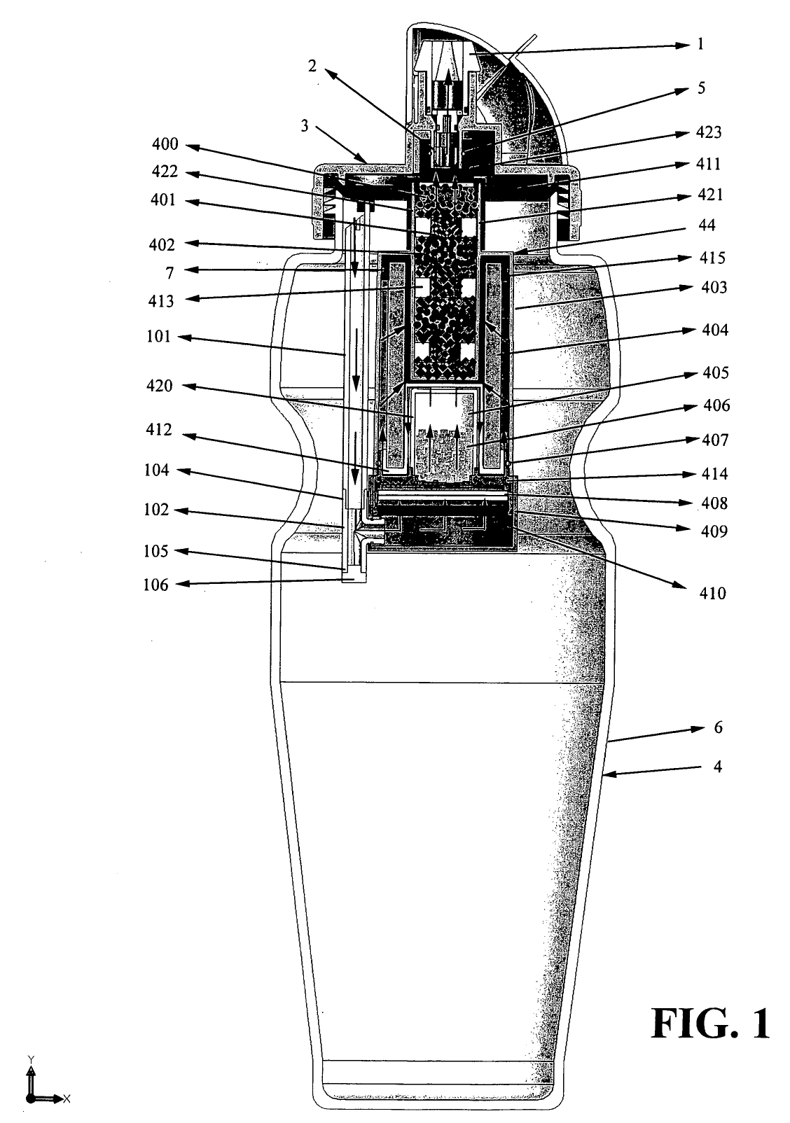

Referring to FIG. 1, a bottle 4 includes a closure device 3 for closing a container 6 used for containing liquids. An outlet connector 411 is provided to cover up water treatment unit 44 and is positioned in between opening of container 6 and closure device 3. An outlet tube 423 of outlet connector 411 connects water treatment unit 44 to an outlet tube 2 of closure device 3 and is sealed up by an O-ring 5. Water treatment unit 44 includes a pre-filter element 408, an inner pre-treatment element 405, a first chamber 404 containing a first treatment medium which water to be treated flows in a radically horizontal direction and a second chamber 422 containing a second treatment medium which water to be treated flows in a vertical direction. Water flows into water treatment unit 44 through a tube 101. Tube 101 is connected to a facing up inlet 104 of an inlet connector 102. Inlet connector 102 is attached to a bottom cover 409 of water treatment unit 44 with a facing down inlet 105 covered up by a cover plate 106. First, water is up flow through pre-filter element 408, which is held firmly in a base 414 of water treatment unit 44 by a holding ring 410. Holding ring 410 has only 8 radical ribs and does not block any water flow. Pre-filter element 408 is a sediment filter of rating from 1 micron to 50 micron and the typical rating is 20 micron. The snap on design of holding ring 410 can be removed from base 414 for taking out and replacing pre-filter element 408, if needed. Base 414 is connected to a housing 403 of water treatment unit 44 and is sealed up by an O-ring 407. Then water exits pre-filter element and flows into an inner pre-treatment element 405. Inner pre-treatment element 405 contains granular filter media 406 in a housing 420 of inner pre-treatment element 405. Granular filter media can be copper zinc alloy and/or mineral stone such as bakuhan stone or taicho stone (commonly used in Japan). Therefore, water exits inner pre-treatment element 405 and flows radically into a first chamber 404 through the gap in between housing 420 and a bottom cover 412 first and then the gap in between bottom cover 412 and base 414. A hollow carbon block is used as the treatment medium in the first chamber 404. The hollow carbon block is mounted in between the top cover 415 and bottom cover 412 and sealed up with inner wall of the housing 421 of the second chamber 422 (not shown) by the O-ring 7 and O-ring 407 respectively. Then water exits the hollow carbon block and flows into the second chamber 422. The second chamber 422 contains one or more granular filter media in a housing 421 of the second chamber 422. Granular filter media can be granular quartz 400, granular magnetite 401, granular infrared ceramic 402 and annular magnet 413. Then water exits the second chamber 422 and flows out of water treatment unit 44. Eventually, water exits bottle 4 through a mouthpiece 1 of closure device 3.

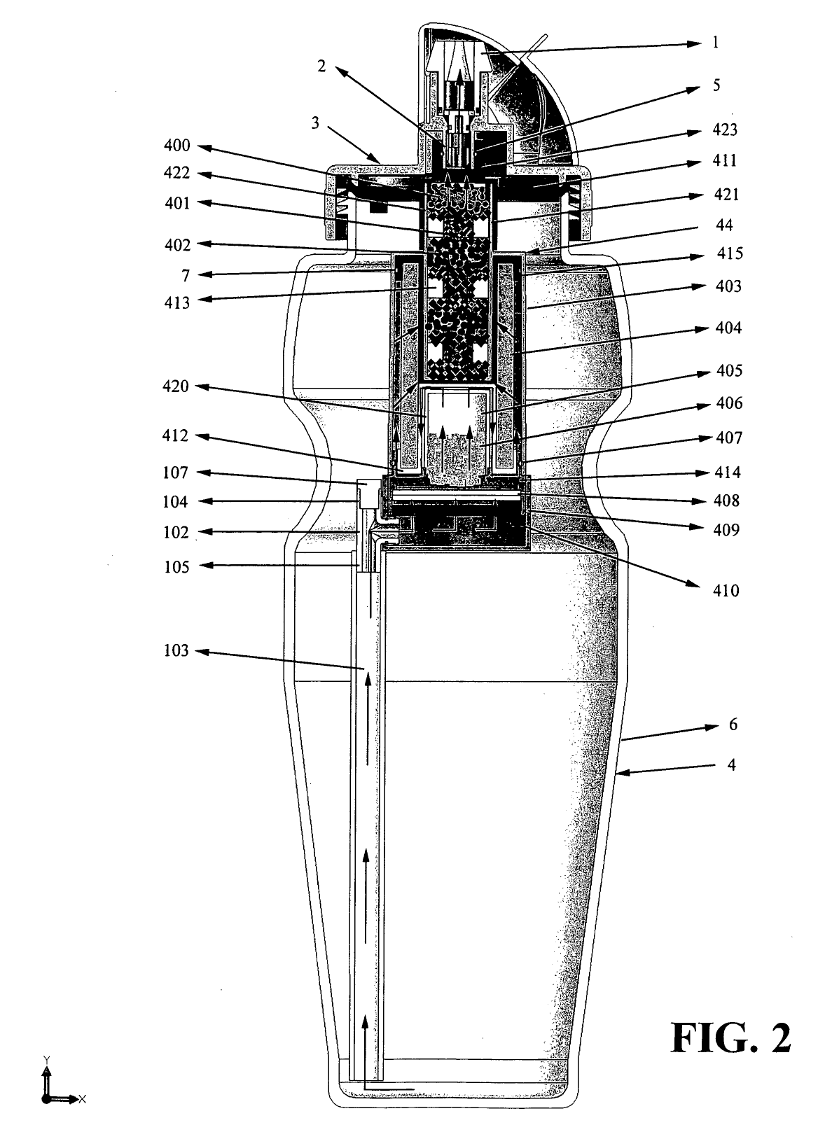

FIG. 2 shows the same features as in FIG. 1, with tube 101 being replaced by a cover 107 and cover 106 being replaced by a tube 103.

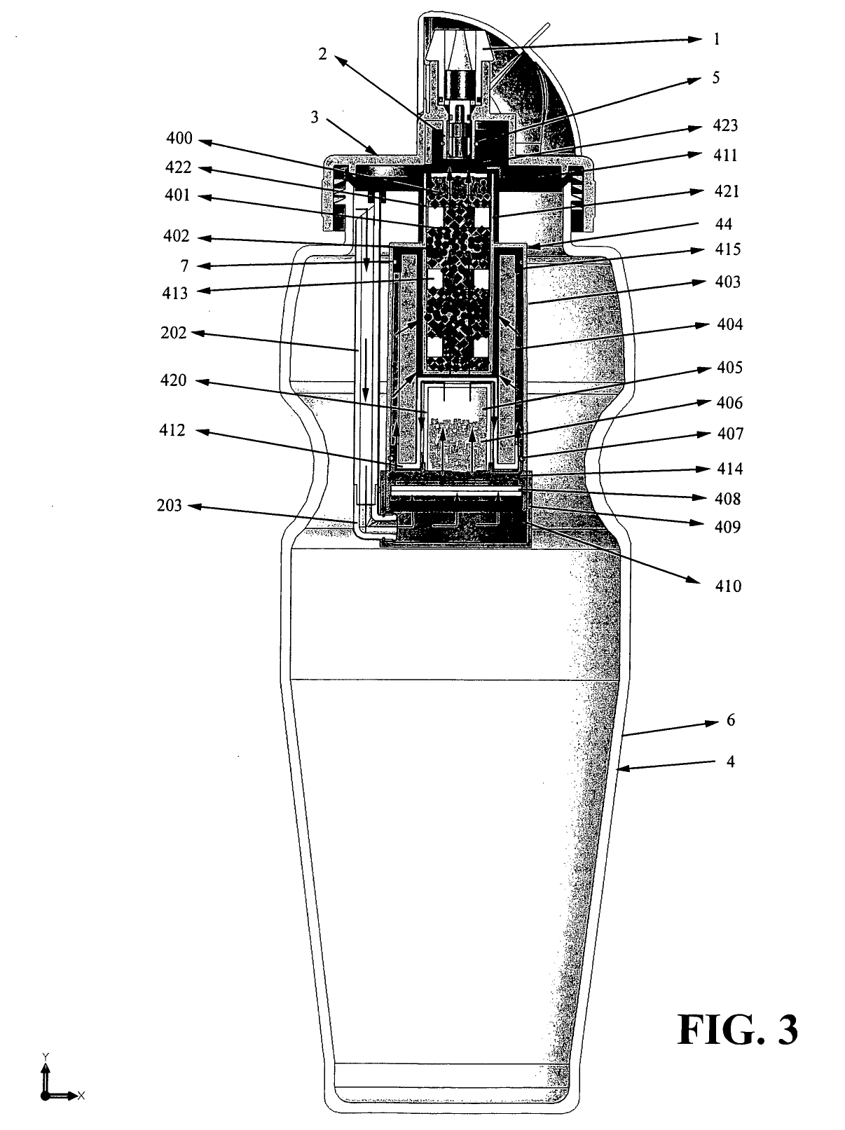

FIG. 3 shows the same features as in FIG. 1, with inlet connector 102 being replaced by a rotary connector 203 with the inlet facing up and being attached by a tube 202.

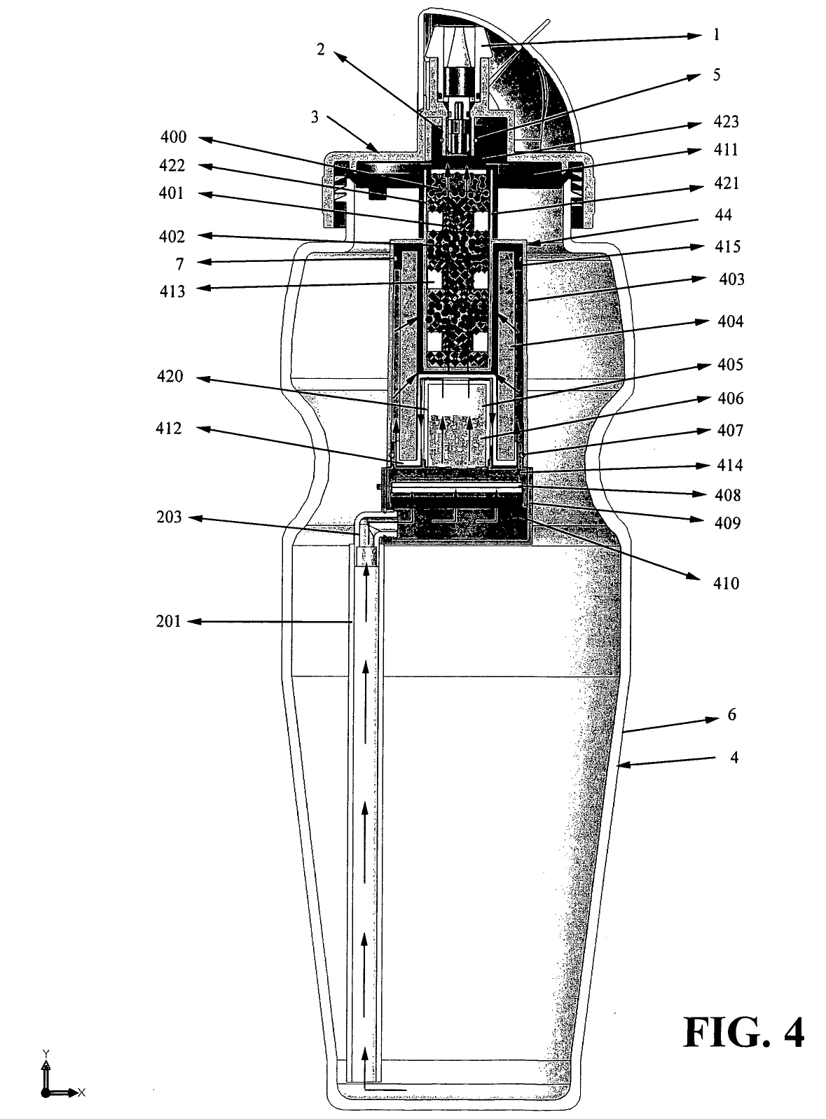

FIG. 4 shows the same features as in FIG. 3, with rotary connector 203 having the inlet facing down and attached by a tube 201.

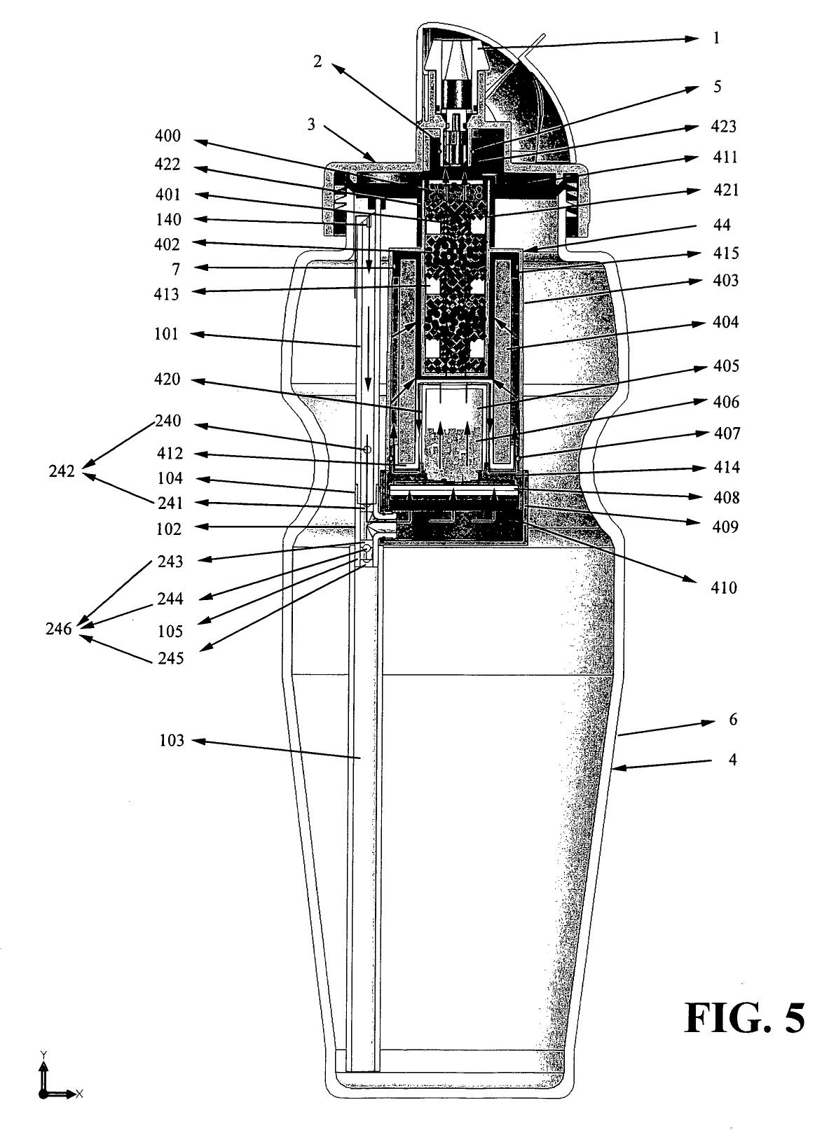

FIG. 5 shows the same features as in FIG. 1, with bottle 4 being tipped up and with cover 106 being replaced by tube 103. A check valve mechanism 242 and a check valve mechanism 246 are integrated into tube 101 and tube 103, respectively. Check valve mechanism 242 includes a ball 240 with density higher than liquid, a soft plastic seat 241 and a stop plate 140. Check valve mechanism 246 includes a ball 244 with density higher than liquid, a soft plastic seat 243 and a soft plastic seat 245. When the bottle 4 is tipped up for drinking water, ball 240 is away from soft plastic seat 241 and is also prevented from coming out of tube 101 by stop plate 140. Water flows into water treatment unit 44 through tube 101. At the same time, ball 244 seats firmly onto soft plastic seat 243, thus preventing water from flowing into water treatment unit 44 from tube 103.

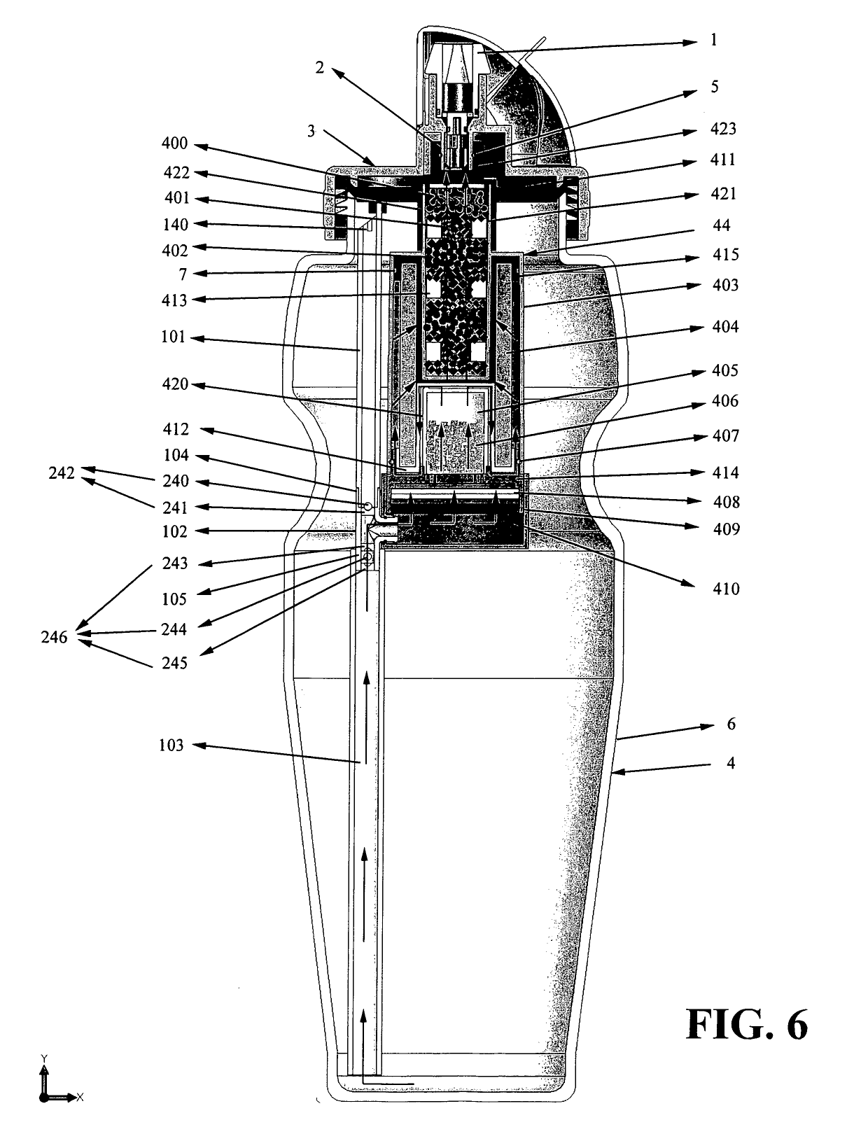

FIG. 6 shows the same features as in FIG. 5, with bottle 4 being in vertical position. Ball 240 seats firmly onto soft plastic seat 241 and prevents water from flowing into water treatment unit 44 from tube 101. When drinking water from bottle 4, ball 243 is away from soft plastic seat 245 and not touching soft plastic seat 243. Water flows into water treatment unit 44 through tube 103. When water flow stops, ball 243 seats firmly onto soft plastic seat 245, thus preventing water already entered water treatment unit 44 from flowing back into container 6.

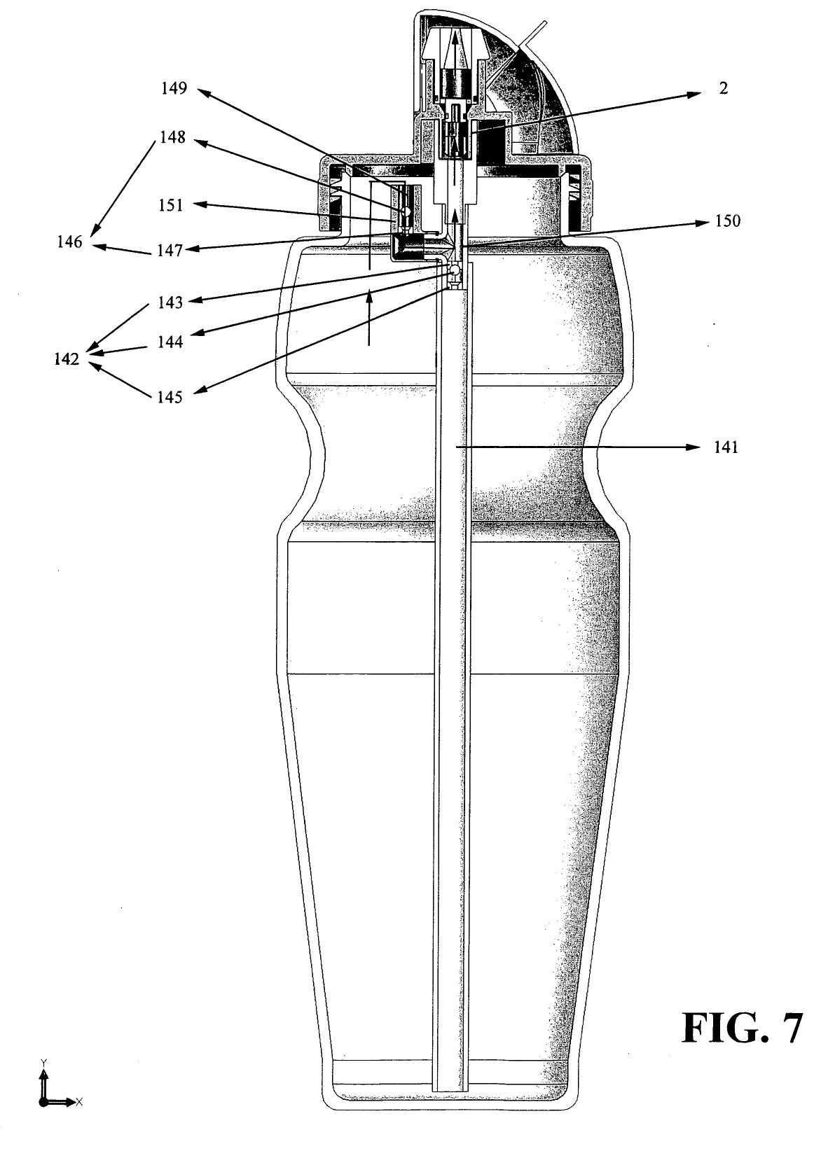

FIG. 7 shows the same features as in FIG. 5, but without water treatment unit 44. A connector 150 is attached to outlet tube 2. A check valve mechanism 146 and a check valve mechanism 142 are integrated into tube 151 and tube 141, respectively. Check valve mechanism 146 includes a ball 148 with density higher than liquid, a soft plastic seat 147 and a stop plate 149. Check valve mechanism 142 includes a ball 144 with density higher than liquid, a soft plastic seat 143 and a soft plastic seat 145. When the bottle 4 is tipped up for drinking water, ball 148 is away from soft plastic seat 147 and is also prevented from coming out of tube 151 by stop plate 149. Water flows out of bottle 4 through connector 150 from tube 151. At the same time, ball 144 seats firmly onto soft plastic seat 143 and prevent water from flowing into connector 150 from tube 141.

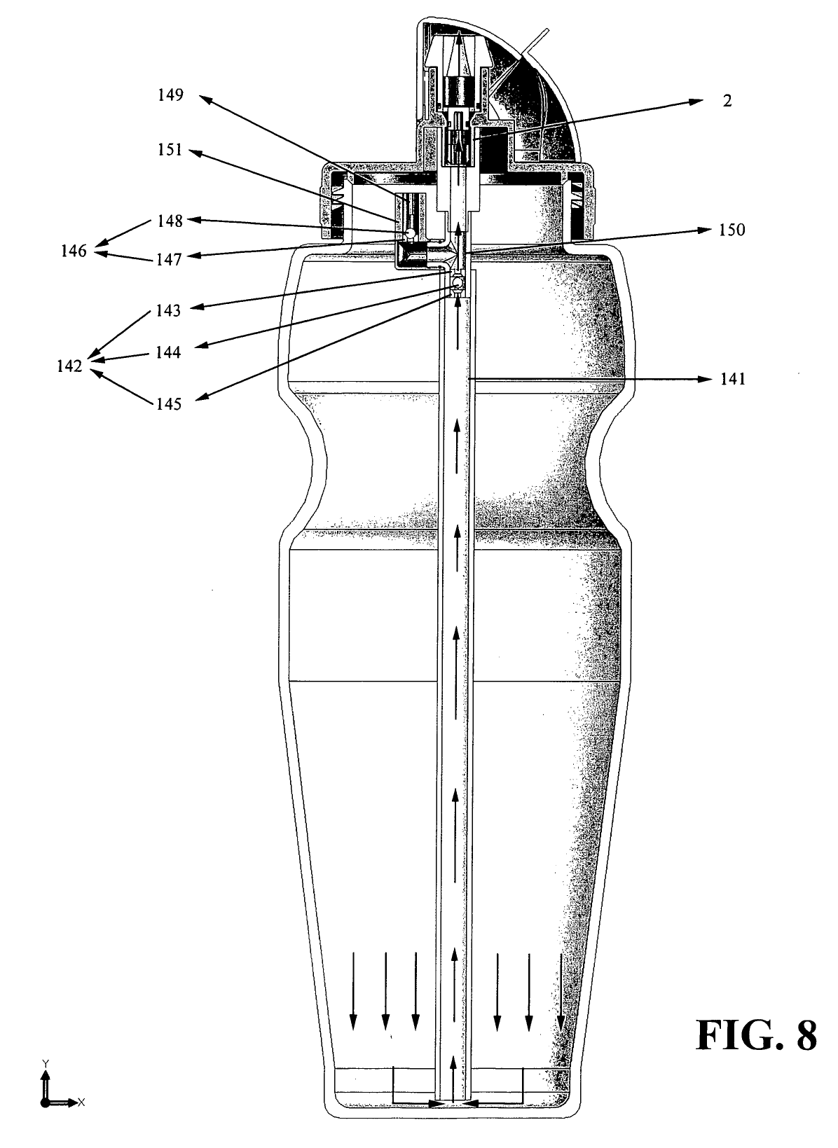

FIG. 8 shows the same features as in FIG. 7, with bottle 4 in vertical position. Ball 148 seats firmly onto soft plastic seat 147 and prevents water from flowing into connector 150 from tube 151. When drinking water from bottle 4, ball 144 is away from soft plastic seat 145 and not touching soft plastic seat 143. Water flows out of bottle 4 through connector 150 and tube 141. When water flow stops, ball 144 seats firmly onto soft plastic seat 145, thus preventing water already entered connector 150 from flowing back into container 6.

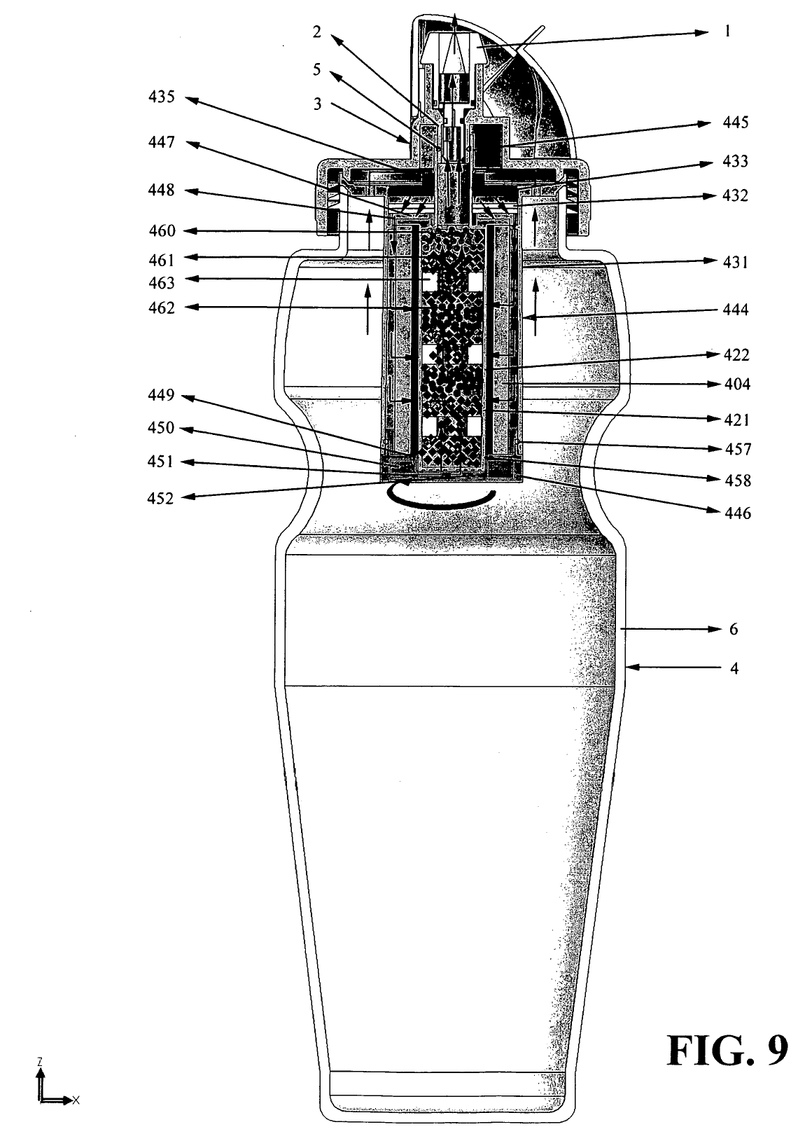

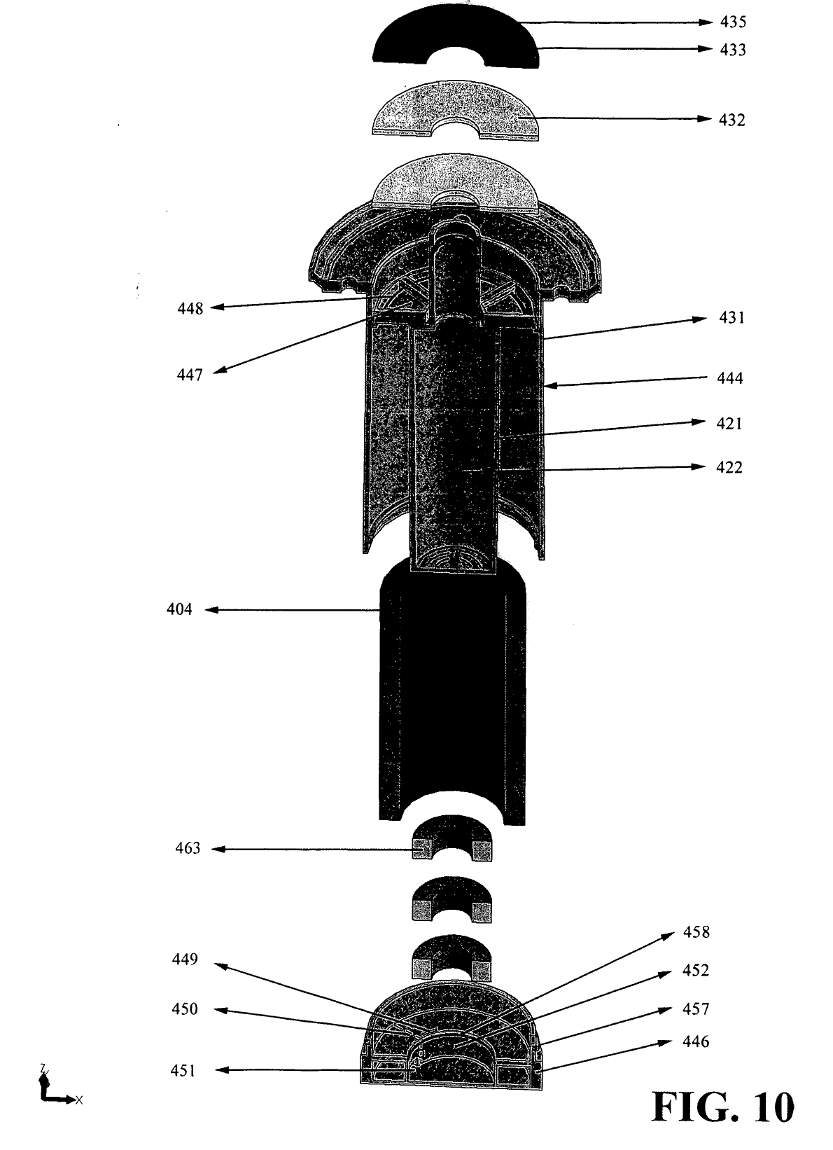

Referring to FIG. 9, a bottle 4 includes a closure device 3 for closing a container 6 used for containing liquids. A housing 431 of a water treatment unit 444 is positioned in between container 6 and closure device 3 with an outlet tube 445 of water treatment unit 444 connected to outlet tube 2 of closure device and is sealed up by an O-ring 5. Water treatment unit 444 includes a pre-filter element 432, a first chamber 404 containing a first treatment medium which water to be treated flows in a radically horizontal direction, a third chamber 446 containing a third treatment medium which water to be treated flows in an annular direction and a second chamber 422 containing a second treatment medium which water to be treated flows in a vertical direction. An inlet tube 435 of a holding plate 433 is also located at the center of the top surface of water treatment unit 444 with inner wall of inlet tube 435 larger than the outer wall of outlet tube 445. FIG. 10 shows details of an exploded view of water treatment unit 444. When the bottle is tipped up for drinking water, water flows into the filter assembly through the annular gap in between the outer wall of the outlet tube 445 and the inner wall of the inlet tube 435. First, water flows into water treatment unit 444 through a pre-filter element 432 with inner diameter slightly larger than outer wall of outlet tube 445 of water treatment unit 444 and outer diameter slightly smaller than inner wall of top opening of housing 431 is placed in between a top plate 447 of housing 43 land holding plate 433. Pre-filter element 432 is a sediment filter of rating from 1 micron to 50 micron and the typical rating is 20 micron. The snap-on design of holding plate 433 can be removed from housing 431 for taking out and replacing pre-filter element 432, if needed. An annular opening 448 is located on the top plate 447 with inner diameter larger than the first chamber 404 and outer diameter smaller than inner wall of housing 431. FIG. 10 shows details of an exploded view of water treatment unit 444. Then water flows through annular opening 448 into the space between inner wall of housing 431 and outer wall of the first chamber 404. A hollow carbon block is used as the treatment medium in the first chamber 404. Then water exits hollow carbon block and flows into a third chamber through an inlet opening 449 of the third chamber 446. There is a partition plate 450 located adjacent to inlet opening 449 for keeping water flows annularly in clockwise direction for 360 degrees until water reaches an outlet opening 451 on an inner annular wall 452 of the third chamber 446. FIG. 10 shows details of an exploded view of water treatment unit 444. The third chamber 446 contains one or more granular filter media and/or magnet in any shape. Thereafter, water exits the third chamber 446 and flows into a second chamber 422. The second chamber 422 contains one or more granular filter media in a housing 421 of the second chamber 422. Granular filter media can be granular quartz 460, granular magnetite 461, granular infrared ceramic 462 and annular magnet 463. Then water exits the second chamber 422 and flows out of water treatment unit 444. Eventually, water exits bottle 4 through a mouthpiece 1 of closure device 3.

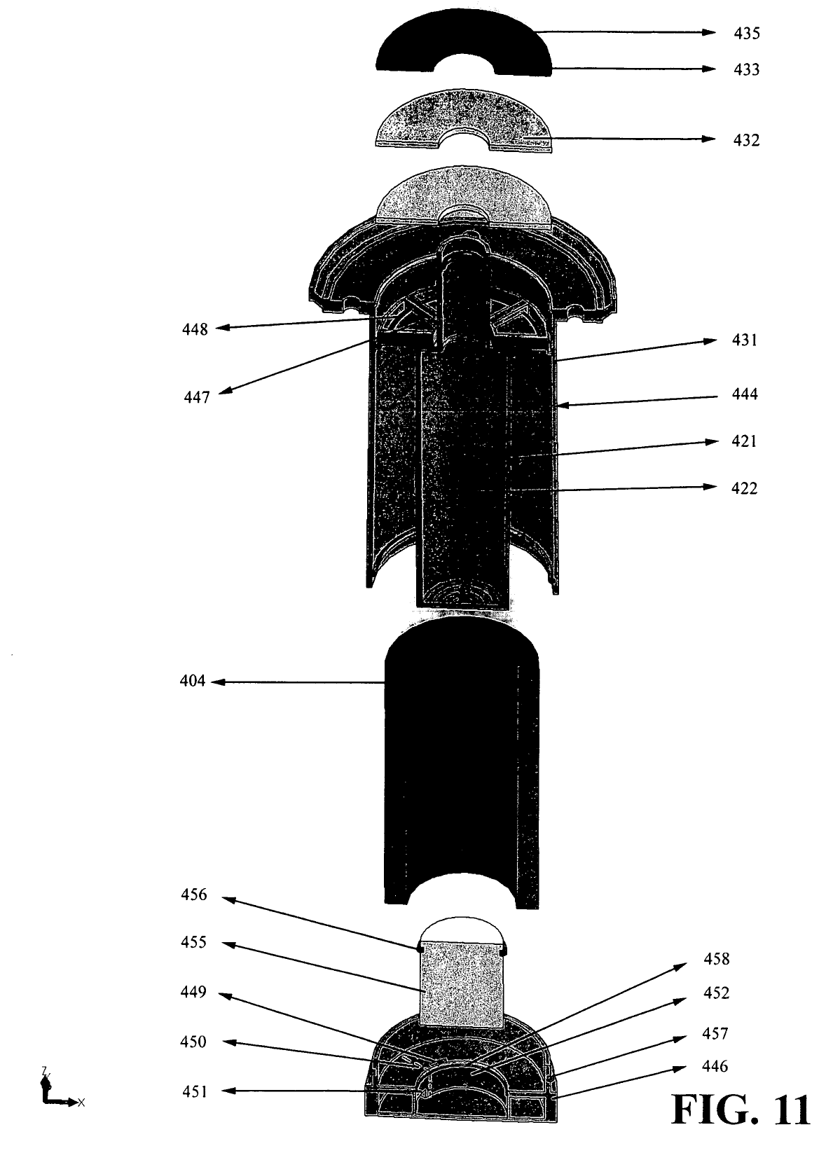

FIG. 11 shows the same features as in FIG. 10, whereby magnetic treatment element is replaced by sub-micorn filter 455 in a second chamber 422.

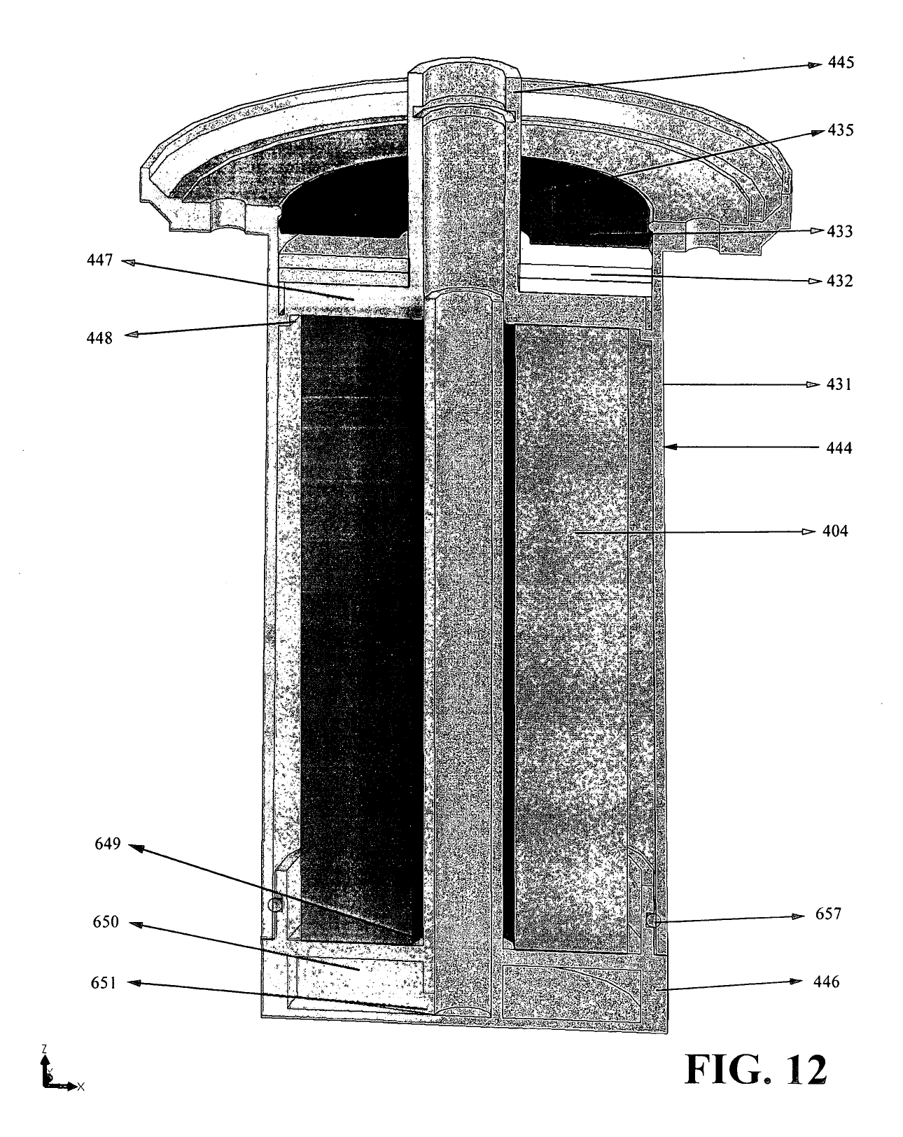

FIG. 12 shows the same features as in FIG. 10, without a second chamber 422.

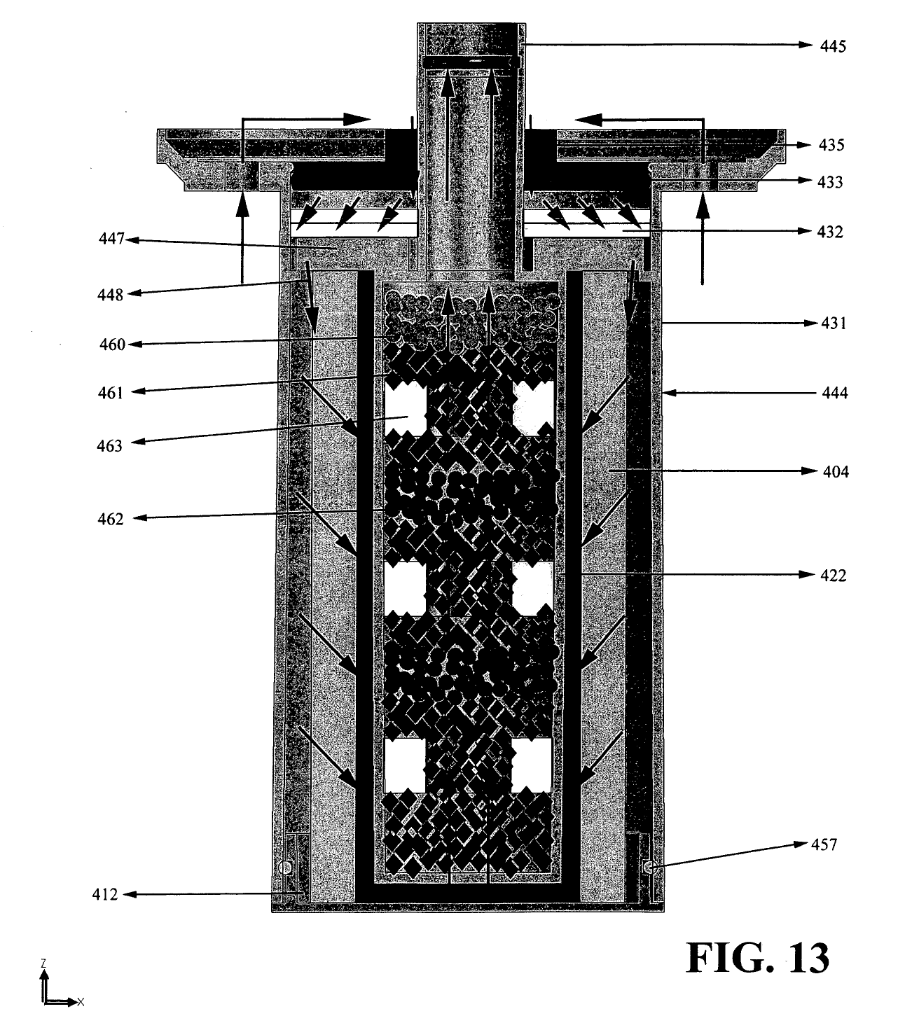

FIG. 13 shows the same features as in FIG. 10, without the third chamber 446.

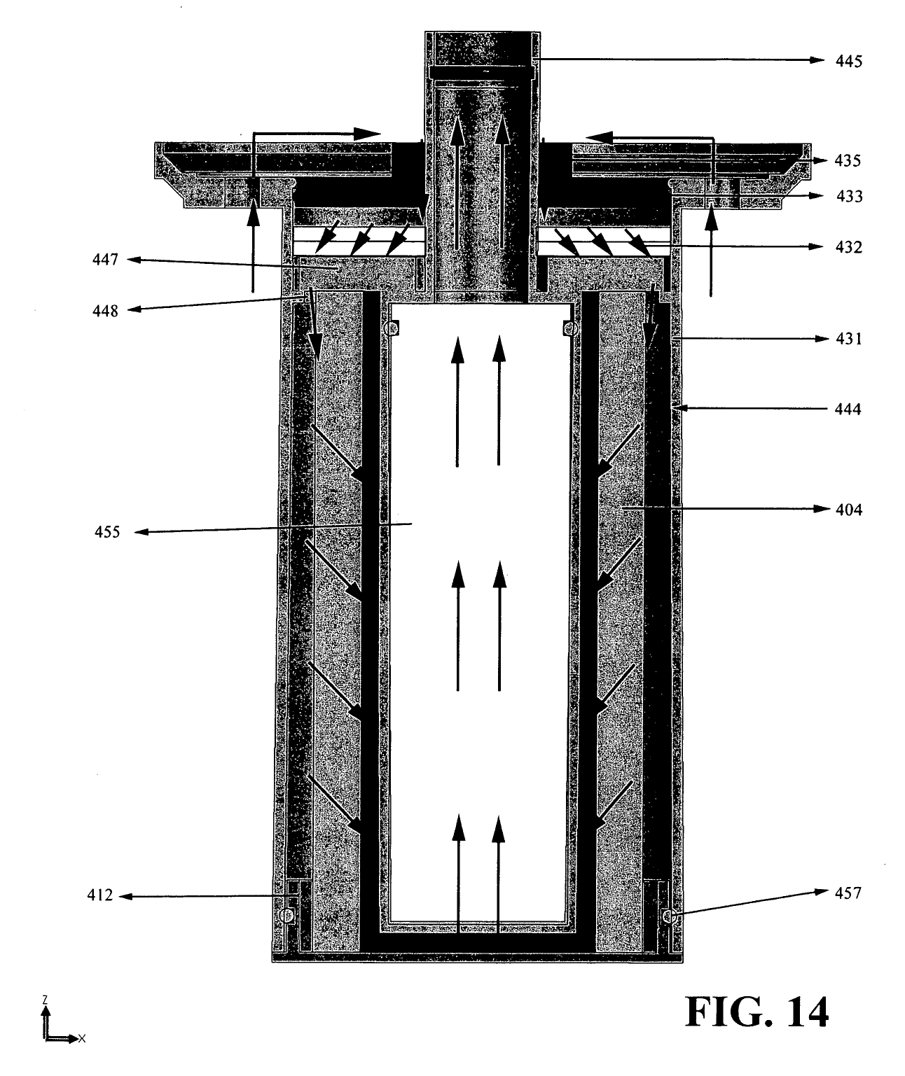

FIG. 14 shows the same features as in FIG. 11, without annular post-treatment element 446.

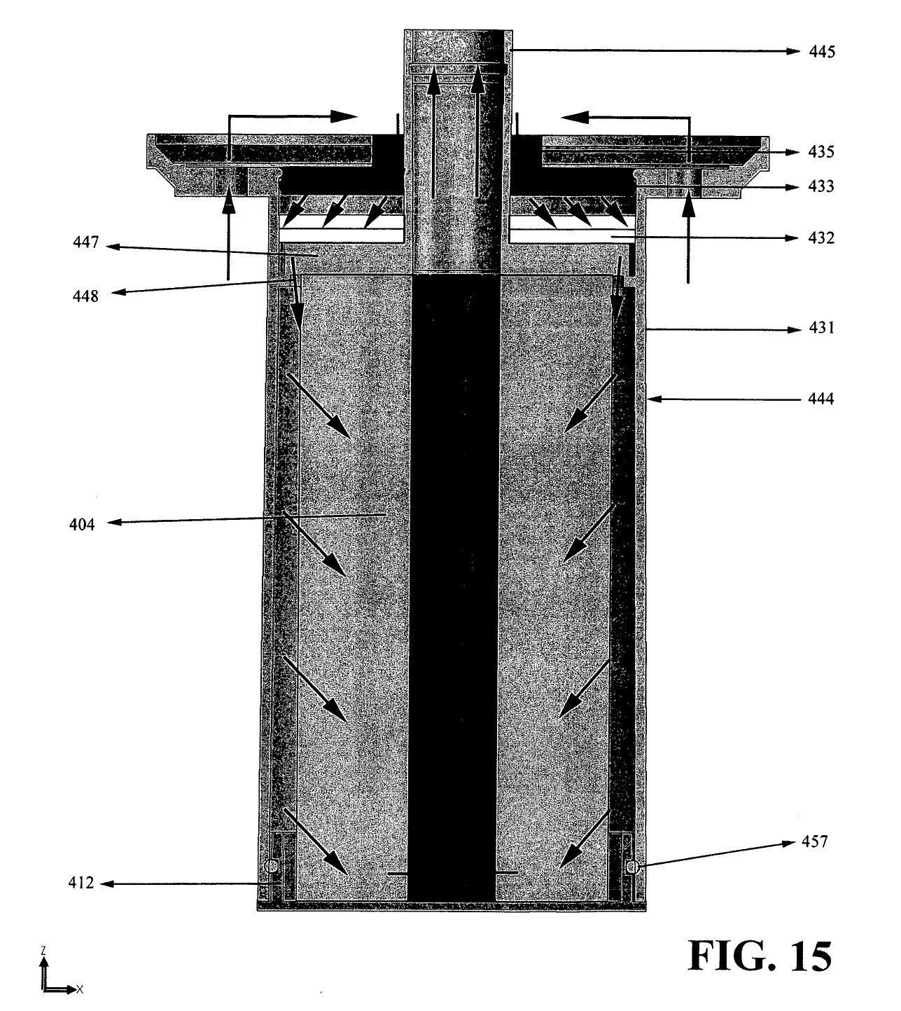

FIG. 15 shows the same features as in FIG. 10, without the third chamber 446 and a second chamber 422.

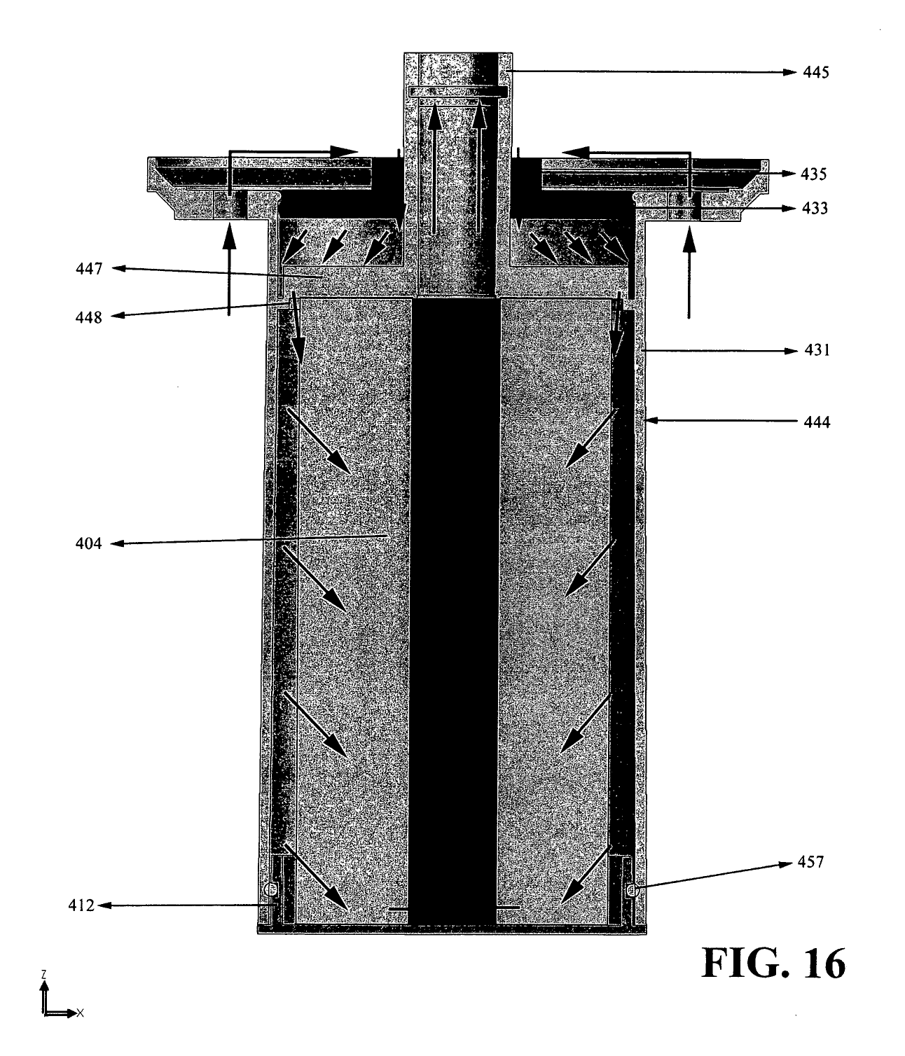

FIG. 16 shows the same features as in FIG. 10, without pre-filter element 432, the second chamber 422 containing the second treatment medium which water to be treated flows in a vertical direction and the third chamber 446 containing a third treatment medium which water to be treated flows in an annular direction.

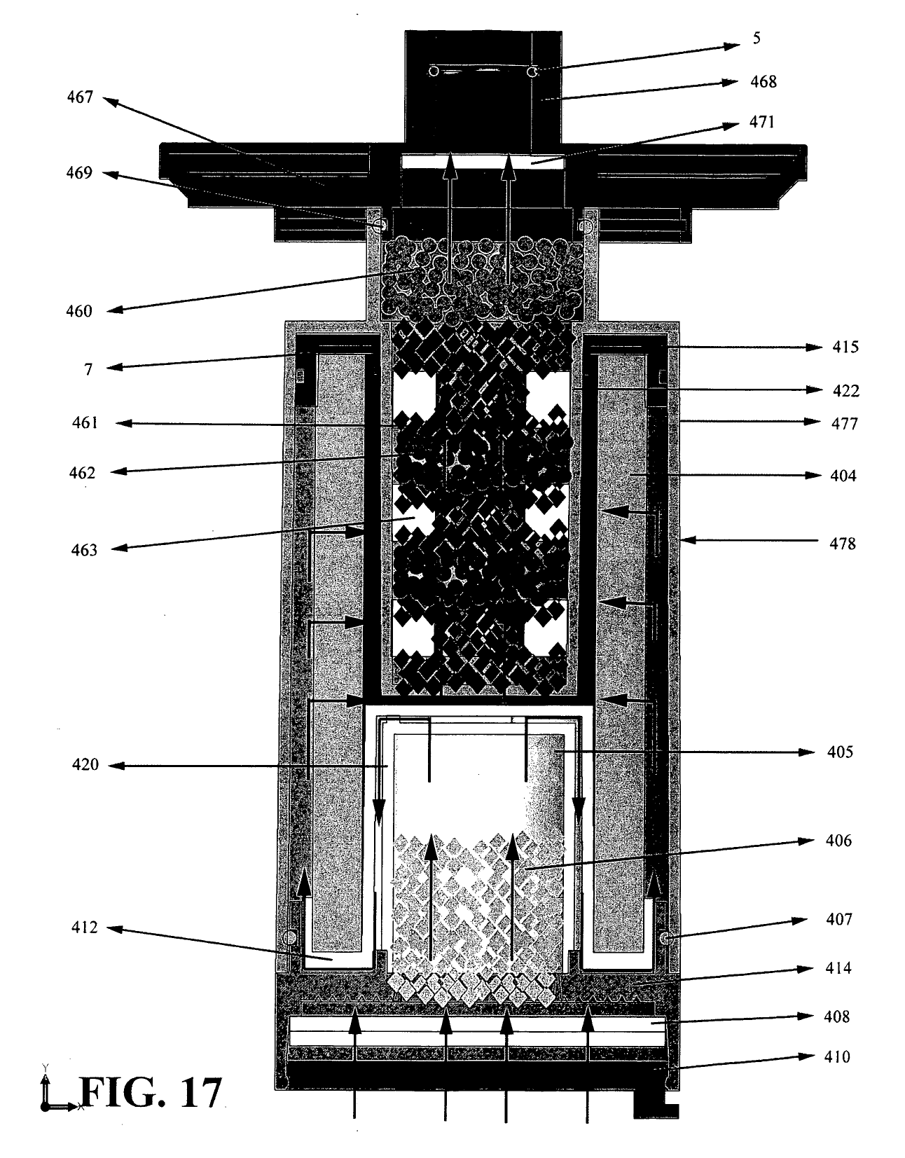

FIG. 17 shows the same features as in FIG. 1, without bottle 4.

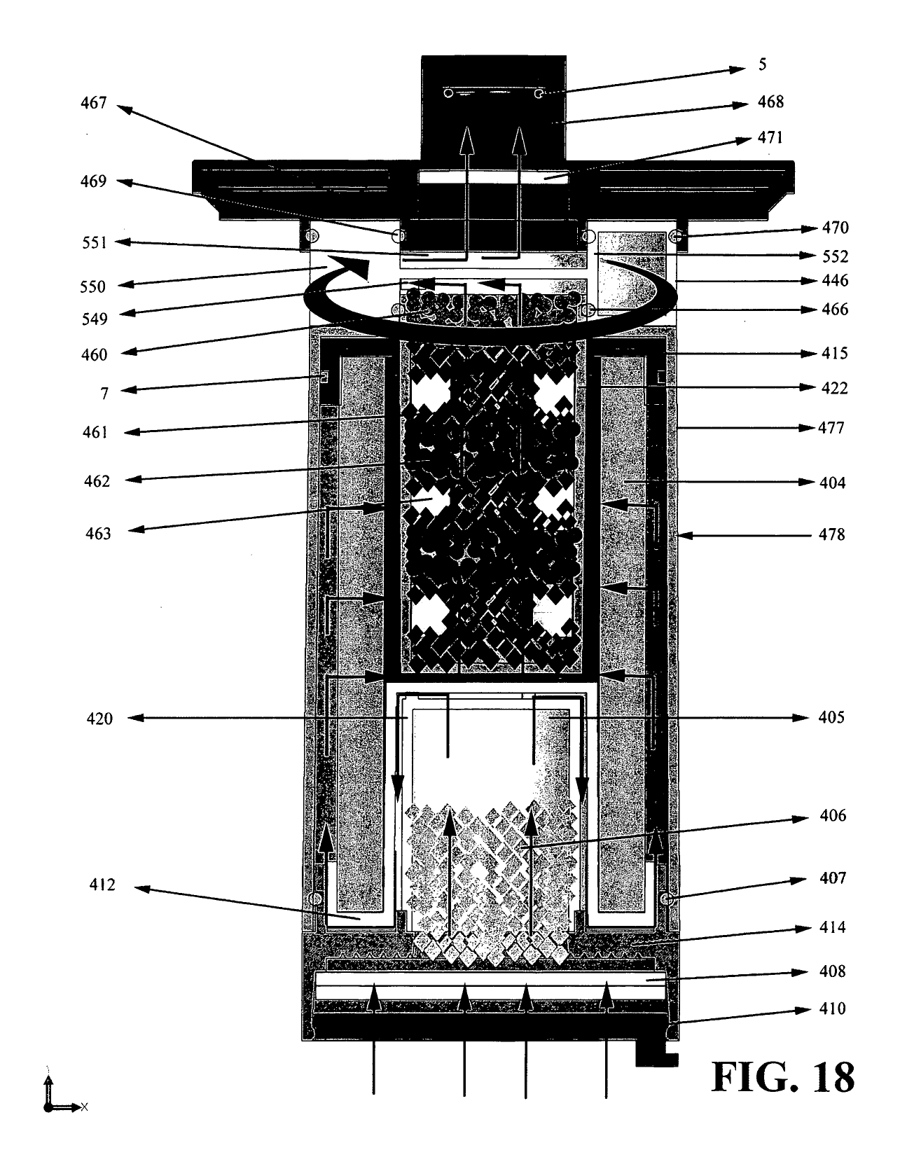

FIG. 18 shows the same features as in FIG. 17, with additional third chamber 446 containing a third treatment medium which water to be treated flows in an annular direction. Water exits the second chamber 422 and flows into the third chamber 446 through an inlet opening 549 of the third chamber 446. There is a partition plate 550 located adjacent to inlet opening 549 for keeping water flows annularly in clockwise direction for 360 degrees until water reaches an outlet opening 551 on an inner annular wall 552 of the third chamber 446. The third chamber 446 contains one or more granular filter media and/or magnet in any shape. Then water exits the third chamber 446 and flows out of water treatment unit 44. Eventually, water exits bottle 4 through a mouthpiece 1 of closure device 3.

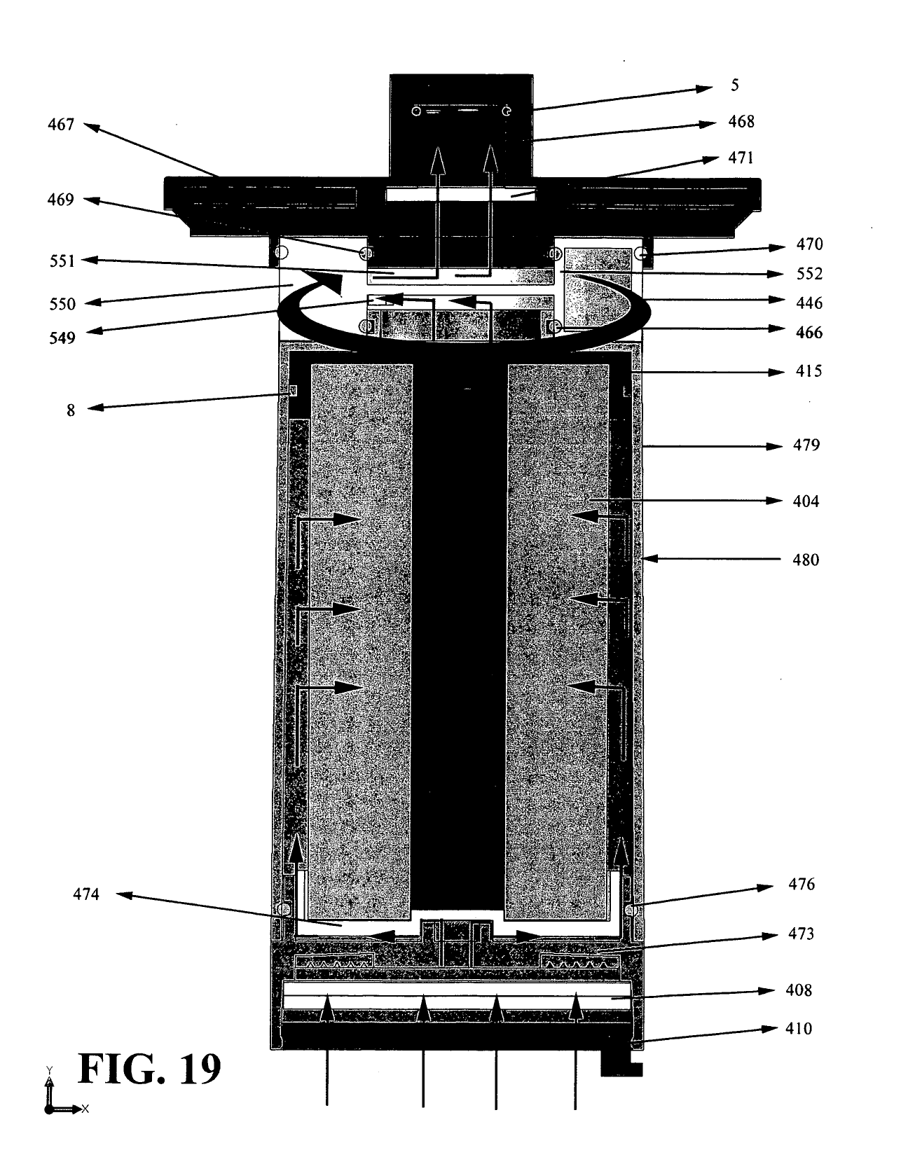

FIG. 19 shows the same features as in FIG. 18, without inner pre-treatment element 408 and the second chamber 422.

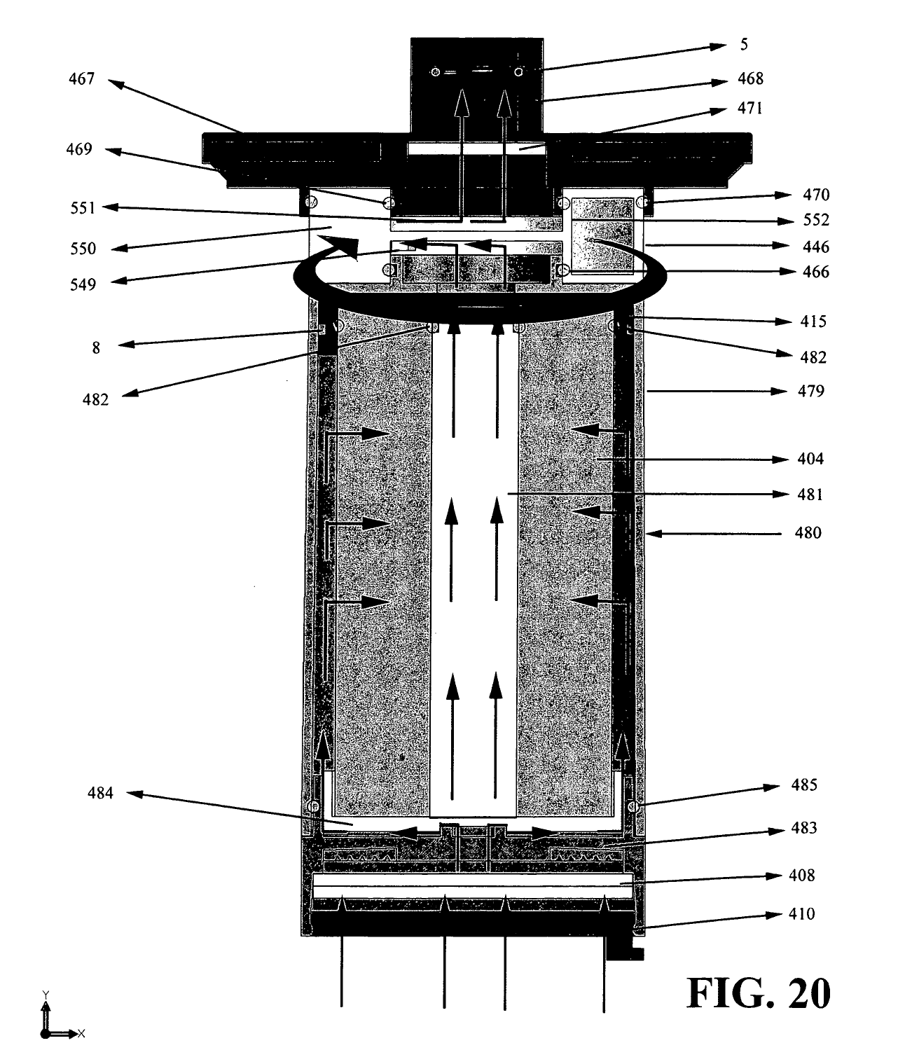

FIG. 20 shows the same features as in FIG. 18, without inner pre-treatment element 408 and the magnetic treatment element is replaced by sub-micorn filter 464 in the second chamber 422.

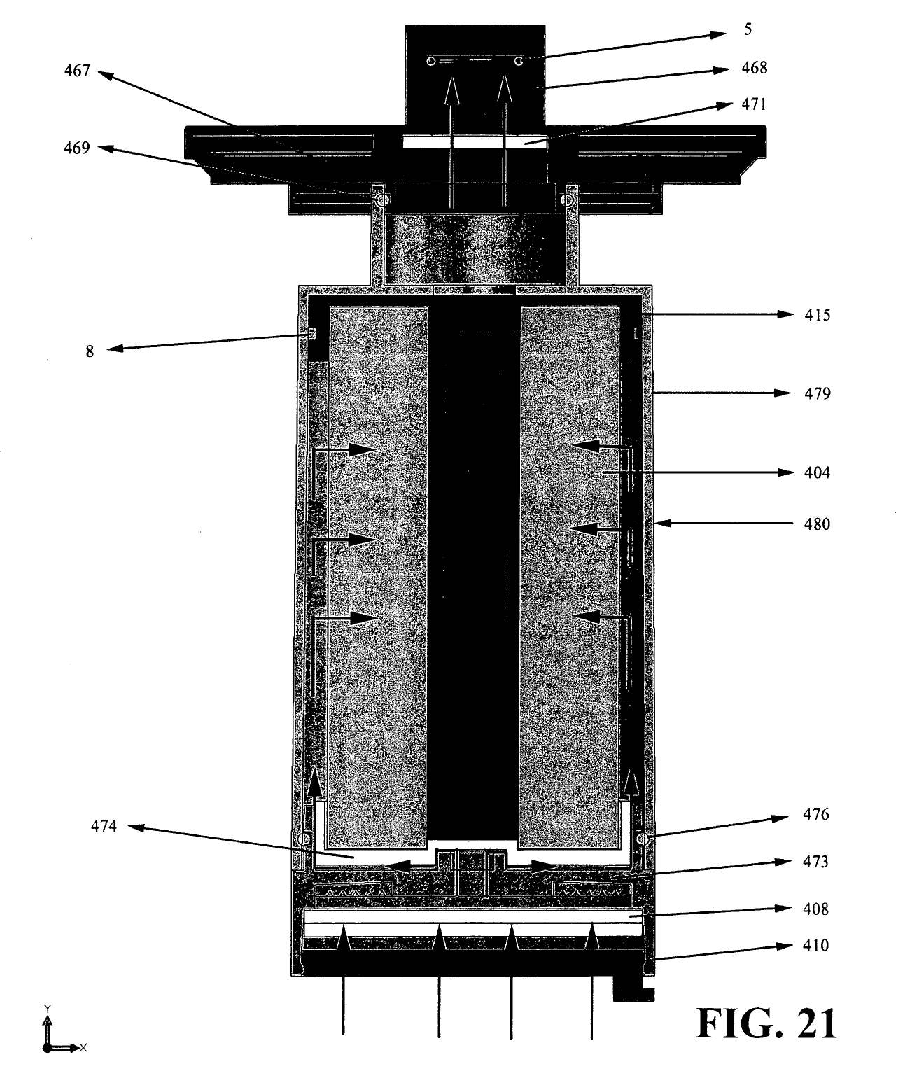

FIG. 21 shows the same features as in FIG. 19, without the third chamber 446.

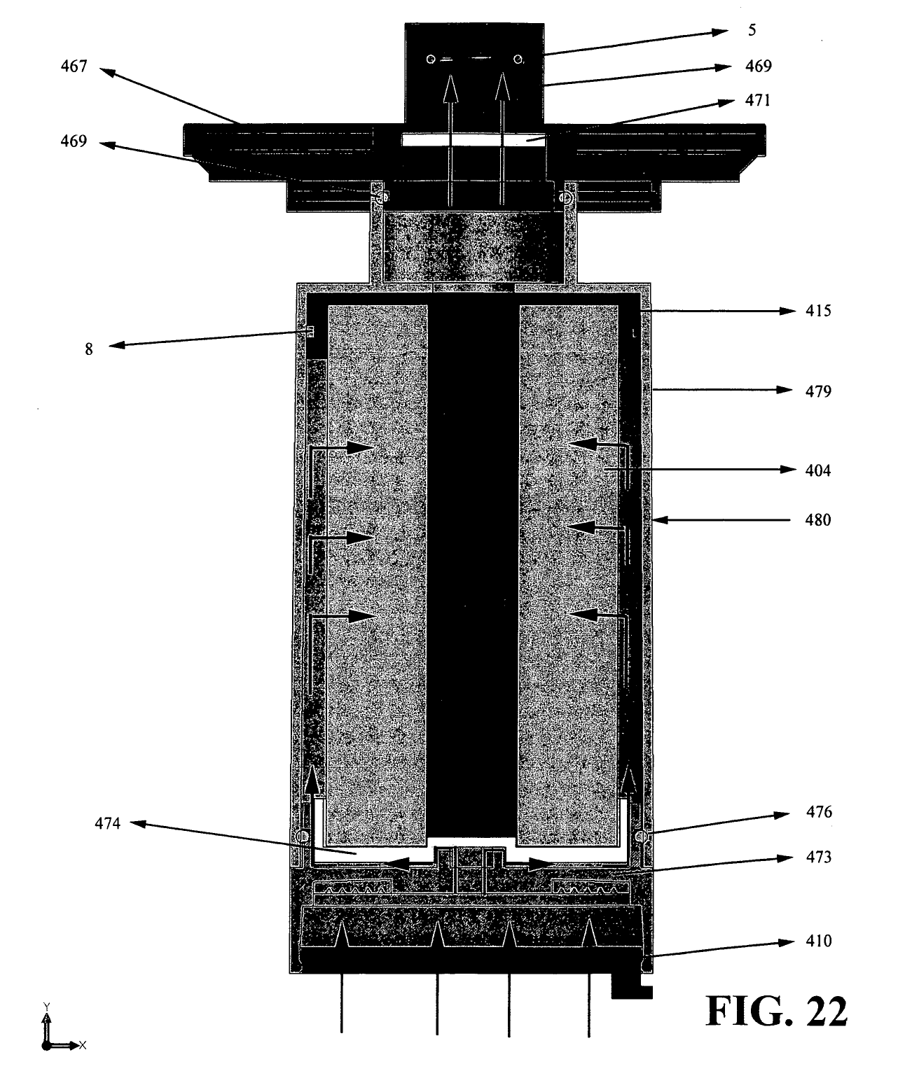

FIG. 22 shows the same features as in FIG. 21, without pre-filter element 432.

It will also be understood that the preferred embodiments of the present invention, which have been described, are merely illustrative of the principles of the present invention. Numerous modifications may be made by those skilled in the art without departing from the true spirit and scope of the invention.

### APPENDIX

Reference numbers for the components of the present invention, as used in the drawings and in the disclosure:
2-outlet tube of closure device 3
3-closure device
4-bottle
5-O-ring
6-container
7-O-ring
8-O-ring
44-water treatment unit
101-tube
102-inlet connector
103-tube
104-facing up inlet of inlet connector 102
105-facing down inlet of inlet connector 102
106-cover
107-cover
140-stop plate
141-tube
142-check valve mechanism
143-soft plastic seat
144-ball
145-soft plastic seat
146-check valve mechanism
147-soft plastic seat
148-ball
149-stop plate
150-connector
151-tube
201-tube
202-tube
203-rotary connector
240-ball
241-soft plastic seat
242-check valve mechanism
243-soft plastic seat
244-ball
245-soft plastic seat
246-check valve mechanism
400-granular quartz
401-granular magnetite
402-granular infrared ceramic
403-housing of water treatment unit 44
404-first chamber
405-inner pre-treatment element
406-granular filter media
407-O-ring
408-pre-filter element
409-bottom cover
410-holding ring
411-outlet connector
412-bottom cover of a first chamber containing a first treatment medium 404
413-annular magnet
414-base
415-top cover of first chamber 404
420-housing of inner pre-treatment element 405
421-housing of second chamber 422
422-second chamber
423-outlet tube of outlet connector 411
431-housing of water treatment unit 444
432-pre-filter element
433-holding plate
404-first chamber
435-inlet tube of holding plate 433
444-water treatment unit
445-outlet tube of water treatment unit 444
446-third chamber
447-top plate of housing 431
448-annular opening on top plate 447
449-inlet opening of annular post-treatment element 446
450-partition plate of annular post-treatment element 446
451-outlet opening of annular post-treatment element 446
452-inner annular wall of annular post-treatment element 446
422-second chamber
421-housing of second chamber 422
455-sub-micorn filter
456-O-ring
457-O-ring
458-O-ring
412-bottom cover of first chamber 404
460-granular quartz
461-granular magnetite 461
462-granular infrared ceramic
463-annular magnet
464-sub-micorn filter
465-annular post-treatment element
466-O-ring
467-outlet connector
468-outlet tube of outlet connector 467
469-O-ring
470-O-ring
471-filter element
415-top cover of first chamber 404
473-base
474-bottom cover of first chamber 404
404-first chamber
476-O-ring
477-housing of water treatment 478
478-water treatment unit
479-housing of water treatment 480
480-water treatment unit
481-sub-micorn filter
482-O-ring
483-base
484-bottom cover of sub-micorn filter 481
485-O-ring
446-third chamber
549-inlet opening of third chamber 446
550-partition plate of third chamber 446
551-outlet opening of third chamber 446
552-inner annular wall of third chamber 446
446-third chamber
649-inlet opening of third chamber 446
650-partition plate of third chamber 446
651-outlet opening of third chamber 446
657-O-ring

What is claimed is:

1. A water treatment unit integrated in a container for treating water in the container which flows through said unit, comprising:
an inlet connector with two inlets attached to the bottom of said unit with one inlet facing up and the other inlet facing down; whereby when one of said inlets is covered up, then a tube is connected to the other one of said inlets for introducing water to be treated by said unit;
an outlet tube positioned at the center of the top surface of said unit for discharging water which has been treated by said unit; and
a first chamber containing a first treatment medium through which water to be treated flows in a radically horizontal direction during treatment; and whereby during treatment water flows from said inlet connector and through said unit and said outlet tube.

2. The unit of claim 1, wherein said first treatment medium is a hollow carbon block.

3. The unit of claim 1, further comprising a second chamber containing a second treatment medium through which water to be treated flows in a vertical direction.

4. The unit of claim 3, wherein said second treatment medium is a magnetic treatment element.

5. The unit of claim 3, wherein said second treatment medium is a sub-micorn filter.

6. The unit of claim 3, further comprising a third chamber containing a third treatment medium through which water to be treated flows through during treatment.

7. The unit of claim 6, wherein the flow through the third treatment medium during treatment is in a substantially annular direction.

8. The unit of claim 6, wherein said third treatment medium is a magnetic treatment element.

9. A water treatment unit incorporated in a container for treating water in the container which flows through said unit, comprising:
an inlet connector with an inlet attached to the bottom of said unit with a tube attaching to said inlet and said inlet is rotatable to a position facing up or down;
an outlet tube positioned at the center of the top surface of said unit for discharging water which has been treated by said unit;
a first chamber containing a first treatment medium through which water to be treated flows in a radically horizontal direction during treatment; and whereby during treatment water flows from said inlet connector and through said unit and said outlet tube.

10. The unit of claim 9, wherein said first treatment medium is a hollow carbon block.

11. The unit of claim 9, further comprising a second chamber containing a second treatment medium through which water to be treated flows in a vertical direction.

12. The unit of claim 11, wherein said second treatment medium is a magnetic treatment element.

13. The unit of claim 11, wherein said second treatment medium is a sub-micorn filter.

14. The unit of claim 11, further comprising a third chamber containing a third treatment medium through which water to be treated flows through during treatment.

15. The unit of claim 14, wherein the flow through the third treatment medium during treatment is in a substantially annular direction.

16. The unit of claim 14, wherein said third treatment medium is a magnetic treatment element.

17. A water treatment unit integrated in a container for treating water in the container which flows through said unit, comprising:
an inlet connector with two inlets attached to the bottom of said unit, each of said inlets is provided with a tube integrated with a check valve mechanism; whereby said check valve mechanism in said tube connected to said facing down inlet is activated when said unit is tipped up; or said check valve mechanism in said tube connected to said facing up inlet is activated when said unit is in vertical position;
an outlet tube positioned at the center of the top surface of said unit for discharging water which has been treated by said unit;
a first chamber containing a first treatment medium through which water to be treated flows in a radically horizontal direction during treatment; and whereby during treatment water flows from said inlet connector and through said unit and said outlet tube.

18. The unit of claim 17, wherein said first treatment medium is a hollow carbon block.

19. The unit of claim 17, further comprising a second chamber containing a second treatment medium through which water to be treated flows in a vertical direction.

20. The unit of claim 19, wherein said second treatment medium is a magnetic treatment element.

21. The unit of claim 19, wherein said second treatment medium is a sub-micorn filter.

22. The unit of claim 19, further comprising a third chamber containing a third treatment medium through which water to be treated flows through during treatment.

23. The unit of claim 22, wherein the flow through the third treatment medium during treatment in a substantially annular direction.

24. The unit of claim 22, wherein said third treatment medium is a magnetic treatment element.

25. A connector unit integrated in a container to allow water flows from said container, comprising a connector with two inlets attached to an outlet of said container, each of said inlets is provided with a tube integrated with a check valve mechanism; whereby said check valve mechanism in said tube connected to said facing down inlet is activated when said unit is tipped up; or said check valve mechanism in said tube connected to said facing up inlet is activated when said unit is in vertical position; and wherein water flows from container through said connector.

26. A water treatment unit integrated in a container for treating water in the container which flows through said unit, comprising:
an outlet tube positioned at the center of the top surface of said unit for discharging water which has been treated by said unit;
an inlet tube positioned at the center of the top surface of said unit; wherein the inner wall of said inlet tube is larger than the outer wall of said outlet tube, whereby water to be treated is introduced into said unit through an annular gap in between said outer wall of said outlet tube and said inner wall of said inlet tube;
a first chamber containing a first treatment medium through which water to be treated flows in a radically horizontal direction during treatment; and whereby during treatment water flows from said inlet tube and through said unit and said outlet tube.

27. The unit of claim 26, wherein said first treatment medium is a hollow carbon block.

28. The unit of claim 26, further comprising a second chamber containing a second treatment medium through which water to be treated flows in vertical direction.

29. The unit of claim 28, wherein said second treatment medium is a magnetic treatment element.

30. The unit of claim 28, wherein said second treatment medium is a sub-micron filter.

31. The unit of claim 28, further comprising a third chamber containing a third treatment medium through which water to be treated flows through during treatment.

32. The unit of claim 31, wherein the flow through the third treatment medium during treatment is in a substantially annular direction.

33. The unit of claim 31, wherein said third treatment medium is a magnetic treatment element.

34. A water treatment unit incorporated in a container for treating water in the container which flows through said unit, comprising:
an inlet connector with two inlets attached to the bottom of said unit with one inlet facing up and the other inlet facing down; whereby when one of said inlets is covered up, then a tube is connected to the other one of said inlets for introducing water to be treated by said unit;
an outlet tube positioned at the center of the top surface of said unit for discharging water which has been treated from said unit; and
a chamber containing treatment medium through which water to be treated flows in during treatment; and whereby during treatment, water flows from said inlet connector and through said unit and said outlet tube.

35. A water treatment unit incorporated in a container for treating water in the container which flows through said unit, comprising:
an inlet connector with an inlet attached to the bottom of said unit with a tube attaching to said inlet and said inlet is rotatable to a position facing up or down;
an outlet tube positioned at the center of the top surface of said unit for discharging water which has been treated by said unit; and
a chamber containing treatment medium through which water to be treated flows in during treatment; and whereby during treatment, water flows from said inlet connector and through said unit and said outlet tube.

36. A water treatment unit incorporated in a container for treating water in the container which flows through said unit, comprising:
an inlet connector with two inlets attached to the bottom of said unit, each of said inlets is provided with a tube integrated with a check valve mechanism; whereby said check valve mechanism in said tube is connected to said facing down inlet is activated when said unit is tipped up; or said check valve mechanism in said tube connected to said facing up inlet is activated when said unit is in vertical position;
an outlet tube positioned at the center of the top surface of said unit for discharging water which has been treated by said unit;
a chamber containing treatment medium through which water to be treated flows in during treatment; and whereby during treatment, water flows from said inlet connector and through said unit and said outlet tube.

37. A water treatment unit incorporated in a container for treating water in the container which flows through said unit, comprising:
an outlet tube positioned at the center of the top surface of said unit for discharging water which has been treated by said unit;
an inlet tube positioned at the center of the top surface of said unit; wherein the inner wall of said inlet tube is larger than the outer wall of said outlet tube, whereby water to be treated is introduced into said unit through an annular gap in between said outer wall of said outlet tube and said inner wall of said inlet tube;
a chamber containing treatment medium through which water to be treated flows in during treatment; and whereby during treatment, water flows from said inlet, through said unit and said outlet tube.
